(19) United States
(12) Patent Application Publication
(10) Pub. No.: US 2007/0159119 A1
(43) Pub. Date: Jul. 12, 2007

(54) Power system

(75) Inventors: Rodwan T. Adra, Peoria, IL (US); Bruce H. Hein, East Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/328,077

(22) Filed: Jan. 10, 2006

(51) Int. Cl. H02P 1/54

(52) U.S. Cl. 318/56

(57) ABSTRACT

A power system includes a power source with a rotary output member. The power system may also include an electric machine having a rotor and a stator. The rotor of the electric machine may be drivingly connected to the rotary output member of the power source. Additionally, the power system may include a sensor configured to provide a signal relating to at least one of a position of the rotor and a speed of the rotor. The power system may also include power-system controls configured to control electric current supply to the stator dependent upon the signal and control the power source dependent upon the signal.

### TECHNICAL FIELD

The present disclosure relates to power systems and, more particularly, to power systems having one or more electric machines.

### BACKGROUND

Many power systems include electric machines, such as an electric motor/generator, drivingly connected to a power source, such as an internal combustion engine. Electric motor/generators may function either as an electric motor or an electric generator dependent upon whether and in what manner electric current is supplied to the stator of the electric motor/generator. Additionally, the quantity of torque or electricity produced by an electric motor/generator may vary considerably as a function of the manner in which electric current is supplied to the stator of the electric motor/generator. These wide-ranging operating capabilities of electric motor/generators may provide the potential to tailor the operation of a power system to widely varying circumstances by controlling the current supplied to the stator of the electric motor/generator. However, effective control of the torque and/or electricity production of an electric motor/generator through control of the current supplied to the stator may require knowledge of the position, speed, and/or direction of rotation of the rotor.

U.S. Pat. No. 6,968,260 to Okada et al. (“the '260 patent”) shows a vehicle having a power system with an electric motor drivingly connected to an engine and a rotor position sensor. The electric motor of the power system shown in the '260 patent is drivingly connected to the engine by a planetary gear set and a plurality of spur gears. The rotor position sensor is positioned adjacent the rotor of the electric motor so that the rotor position sensor may sense the position of the rotor and produce a signal relating thereto. The power system of the '260 patent also includes an engine speed sensor for sensing the speed of the engine.

The vehicle of the '260 patent also includes an engine control unit and a vehicle control unit. The engine control unit receives the signal from the engine speed sensor and controls the engine dependent upon that signal. The vehicle control unit receives the signal from the rotor position sensor and controls the electric'motor dependent upon that signal. Under some circumstances, the vehicle control unit electrically brakes the mobile machine by operating the electric motor as a generator and directing the electricity generated to a battery of the vehicle.

Although the power system of the '260 patent includes a sensor for sensing the position of the rotor of the electric motor, certain disadvantages persist. For example, using separate, dedicated sensors for sensing the position of the electric motor's rotor and the speed of the engine may entail unnecessary expense. Additionally, because the battery of the vehicle may have a limited energy capacity, utilizing the battery of the vehicle as the only sink for electricity generated in electric braking of the vehicle may limit the amount of electric braking that can be done without overcharging the battery.

The power system of the present disclosure solves one or more of the problems set forth above.

### SUMMARY OF THE INVENTION

One disclosed embodiment relates to a power system having a power source with a rotary output member. The power system may also include an electric machine having a rotor and a stator. The rotor of the electric machine may be drivingly connected to the rotary output member of the power source. Additionally, the power system may include a sensor configured to provide a signal relating to at least one of a position of the rotor and a speed of the rotor. The power system may also include power-system controls configured to control electric current supply to the stator dependent upon the signal and control the power source dependent upon the signal.

Another embodiment relates to a method of operating a power system. The power system may include an electric machine having a rotor and a stator. Additionally, the power system may include a sensor configured to provide a signal relating to at least one of a position of the rotor and a speed of the rotor. The method may include, while the rotor is rotating, controlling electric current supply to the stator in a manner such that the position of the rotor may be determined from electrical activity induced in the stator by the rotation of the rotor. Additionally, the method may include calibrating the signal dependent upon the electrical activity induced in the stator by rotation of the rotor.

A further disclosed embodiment relates to a mobile machine having one or more propulsion devices configured to receive power and utilize that power to propel the mobile machine. The mobile machine may also include a power system configured to selectively provide power to the one or more propulsion devices to propel the mobile machine. The power system may include an internal combustion engine having a rotary output member, a first electric machine drivingly connected to the rotary output member of the internal combustion engine, and a second electric machine. The power system may also include power-system controls configured to, while the mobile machine is in motion, selectively cause the second electric machine to brake the mobile machine by receiving power from one or more of the propulsion devices and utilizing that power to generate electricity. Additionally, the power-system controls may be configured to, while causing the second electric machine to brake the mobile machine, selectively operate the first electric machine as an electric motor to drive the rotary output member of the internal combustion engine.

### BRIEF DESCRIPTION OF THE DRAWINGS

FIG. 1 is a schematic illustration of a first embodiment of a machine according to the present disclosure;

FIG. 2 is a schematic illustration of a second embodiment of a machine according to the present disclosure;

FIG. 3 is a schematic illustration of a third embodiment of a machine according to the present disclosure; and

FIG. 4 is a flow chart illustrating one embodiment of a method of calibrating and validating a signal produced by a sensor.

### DETAILED DESCRIPTION

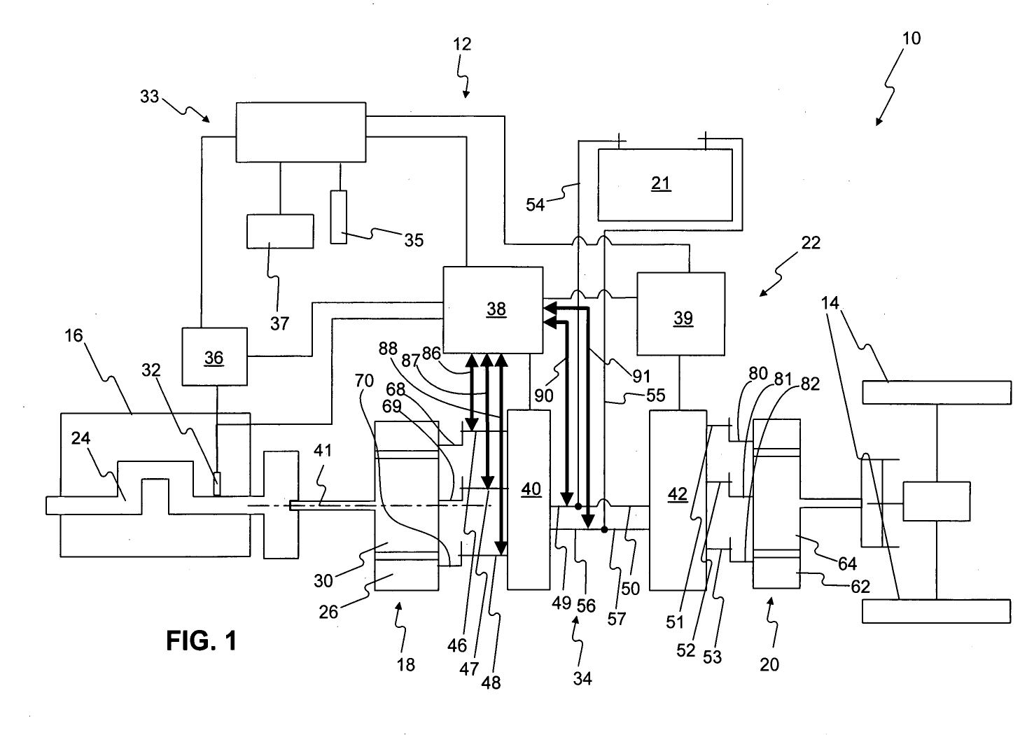

FIG. 1 illustrates one embodiment of a machine 10 having a power system 12 according to the present disclosure. Machine 10 may be a mobile machine, and machine 10 may include one or more propulsion devices 14 in addition to power system 12.

Power system 12 may include an electric machine 18, an electric machine 20, a power source 16, power-system controls 22, and one or more energy sources and/or sinks. Each electric machine 18, 20 may be any type of component configured to operate as an electric motor and/or an electric generator, including, but not limited to a permanent-magnet type motor/generator and a switched-reluctance type motor/generator. Electric machine 18 may include a stator 26, and a rotor 30. A housing (not shown) may support stator 26 in a stationary position. Additionally, the housing may support rotor 30 in a manner allowing rotor 30 to rotate around a rotor rotation axis 41. Electric machine 20 may have a stator 62, a rotor 64 configured and associated with one another similar to stator 26, and rotor 30 of electric machine 18.

Rotor 30 may have multiple poles around rotor rotation axis 41. For example, in embodiments where electric machine 18 is a permanent-magnet type electric machine, rotor 30 may have multiple magnetic poles defined by permanent magnets mounted on and/or inside rotor 30. Similarly, in embodiments where electric machine 18 is a switched-reluctance type electric machine, rotor 30 may have poles defined by geometric features.

Stator 26 may be configured to utilize and/or produce electricity when electric machine 18 operates as an electric motor or generator. Stator 26 may have electrical terminals 68, 69, 70 for receiving and/or supplying electric current. Stator 26 may have stator windings (not shown) connected to terminals 68-70. Each stator winding connected to a terminal 68, 69, 70 may have a plurality of poles, which may or may not be equal in number to the poles of rotor 30. Additionally, in some embodiments, such as some embodiments where electric machine 18 is a permanent-magnet type electric machine, the stator windings may be multi-phase windings configured to utilize multiphase alternating current and/or produce multi-phase alternating current during operation of electric machine 18. For example, the stator windings may be three-phase stator windings with each phase of windings connected to one of terminals 68-70. In some embodiments stator 62 may include similarly configured stator windings connected to terminals 80-82. Furthermore, in some embodiments, such as some embodiments where electric machine 18 and/or electric machine 20 is/are switched reluctance type electric machines, the stator windings of stator 26 and/or stator 62 may be configured to utilize and/or generate unidirectional electric current.

Power source 16 may be any type of component configured to produce power, including, but not limited to, a diesel engine, a gasoline engine, a gaseous fuel driven engine, and a turbine. Power source 16 may include a rotary output member 24, such as a crankshaft. As is shown in FIG. 1, rotary output member 24 may be temporarily or permanently drivingly connected to rotor 30 at a fixed speed ratio.

Power source 16 may include a position/speed sensor 32 which may be any type of device configured to provide a signal relating to the position and/or speed of rotary output member 24. For example, position/speed sensor 32 may be a hall-effect device configured to produce pulses corresponding to certain positions of a rotary member. In some embodiments, position/speed sensor 32 may be configured to provide a signal that relates to the direction of rotation of rotary output member 24 in addition to the position and/or speed thereof. As is shown in FIG. 1, position/speed sensor 32 may be arranged to directly sense the position and/or speed of rotary output member 24. Alternatively, position/speed sensor 32 may be arranged to sense the position and/or speed of any rotary member drivingly connected to rotary output member 24 at a fixed speed ratio. Additionally, in embodiments, such as the one shown in FIG. 1, where rotary output member 24 is drivingly connected to rotor 30 at a fixed speed ratio, the signal provided by position/speed sensor 32 may also relate to the position, speed, and/or direction of rotation of rotor 30.

Power-system controls 22 may include operator controls 33, controllers 36, 38, 39, and an electrical power-transfer system 34. Operator controls 33 may include any types of components configured to transmit operator inputs to other components of machine 10. For example, operator controls 33 may include an accelerator 35 and a brake pedal 37 for receiving acceleration and braking requests from an operator, and operator controls 33 may include various other components for transmitting these and other requests to other components of power system 12.

Each controller 36, 38, 39 may be any type of device configured to execute one or more algorithms for controlling various components of machine 10. Each controller 36, 38, 39 may include one or more processors (not shown) and memory devices (not shown). As FIG. 1 shows, controller 36 may be operatively connected to power source 16 so that controller 36 may control one or more aspects of the operation of power source 16. Controller 36 may be a dedicated controller for controlling power source 16, or controller 36 may be operable to monitor and/or control one more other components of machine 10. As FIG. 1 shows, controllers 38, 39 may be operatively connected to power regulators 40, 42, respectively, so that controllers 38, 39 may control one or more aspects of the operation of power regulators 40, 42. Controllers 38, 39 may be dedicated controllers for controlling the operation of power regulators 40, 42, respectively, or one or both of controllers 38, 39 may be configured to monitor and/or control one or more other components of machine 10.

Each of controllers 36, 38, 39 may be operatively connected to various components configured to provide controllers 36, 38, 39 with information for use in controlling power source 16, power regulator 40, and power regulator 42, respectively. For example, as FIG. 1 shows, controllers 36, 38 may both be operatively connected to position/speed sensor 32, and controllers 36, 38, 39 may each be operatively connected to operator controls 33. Additionally, power-system controls 22 may include information channels 86-88 configured to provide controller 38 with information relating to the voltage and/or current in the stator windings connected to terminals 68-70 of stator 62. Furthermore, power-system controls 22 may include an information channel 90 and an information channel 91 configured to provide controller 38 with information relating to the voltage and/or current in a power line 49 and a power line 56, respectively. Moreover, each of controllers 36, 38, 39 may be operatively connected to various other sensors, controllers, and/or other sources of information not shown in FIG. 1.

Electrical power-transfer system 34 may include power regulators 40, 42 and power lines 46-57 connecting electric machines 18, 20. Each power line 46-57 may include any component or system of components operable to transfer electricity between two points.

Power regulator 40 may be any type of device operable, under the control of controller 38, to regulate one or more aspects of electrical power transfer between electric machine 18 and power lines 49, 56. For example, power regulator 40 may be operable to regulate the direction and rate of power transfer between terminals 68-70 of stator 26 and power lines 49, 56, such as by regulating the voltage in power lines 46-49, 56. Additionally, power regulator 40 may be operable to regulate one or more timing aspects of electric current flowing to or from electric machine 18, such as the phase and/or frequency of alternating current flowing to or from terminals 68-70 of stator 26. Furthermore, in some embodiments, power regulator 40 may be operable to convert power between direct current flowing from/to power lines 49, 56 and multi-phase alternating current flowing to/from terminals 68-70 of stator 26.

Power regulator 42 may be any type of device operable, under the control of controller 39, to regulate one or more aspects of electrical power transfer between electric machine 20 and power lines 50, 57. In some embodiments, power regulator 42 may be configured to operate in a similar manner with respect to stator 62 and power lines 50, 57 as power regulator 40 does with respect to stator 26 and power lines 49, 56.

As mentioned above, power system 12 may include one or more energy sources and/or sinks. For example, as FIG. 1 shows, power system 12 may include an electrical storage device 21 connected to electrical power-transfer system 34 through power lines 54, 55. Electrical storage device 21 may be any type of device configured to receive electric current from one or more devices of power system 12, such as electric machines 18, 20, and store at least some of the energy of the electric current for later use in supplying electric current to one or more devices of power system 12. For example, electrical storage device 21 may be a battery or a capacitor.

In addition to, or in place of, electric storage device 21, power system 12 may include various other types of energy sources and/or sinks. For example, in some embodiments, power system 12 may include an additional electric machine (not shown) drivingly connected to a pump (not shown), such as a hydraulic or pneumatic pump, and a fluid-energy storage device (not shown), such as a hydraulic accumulator or air tank connected to the pump. In such embodiments, power system 12 may be operable to selectively store energy from electric current produced by devices such as electric machines 18, 20 by using the electric current to pump fluid into the fluid-energy storage device. Additionally, in some embodiments, power system 12 may include an additional electric machine (not shown) drivingly connected to a flywheel (not shown) or other similar device for storing kinetic energy. In such embodiments, power system 12 may be operable to selectively utilize the additional electric machine to convert electric energy from electric machines 18, 20 into kinetic energy in the flywheel and subsequently convert the kinetic energy in the flywheel back into electric energy. Furthermore, in some embodiments, power system 12 may include provisions (not shown) for connecting power system 12 to one or more external sources of electricity, such as an electrical trolley system (not shown). For example, power system 12 may have provisions for connecting power lines 54, 55 to an electrical trolley system in addition to, or in place of, electrical storage device 21. Moreover, power system 12 may have one or more electrical resistors connected to electrical power-transfer system 34 in addition to, or in place of electrical storage device 21, and power-system controls 22 may be configured to selectively dissipate energy by directing electric current produced by one or both of electric machines 18, 20 through one or more of those resistors.

Each propulsion device 14 may be any type of component configured to receive power from power system 12 and propel machine 10 by transferring that power to the environment surrounding machine 10. For example, as is shown in FIG. 1, propulsion devices 14 may be wheels. Alternatively, propulsion devices 14 may be track units, other types of devices configured to transmit power to the ground, propellers, or other types of devices configured to move fluid to propel machine 10. As FIG. 1 shows, propulsion devices 14 may be drivingly connected to rotor 64 of electric machine 20.

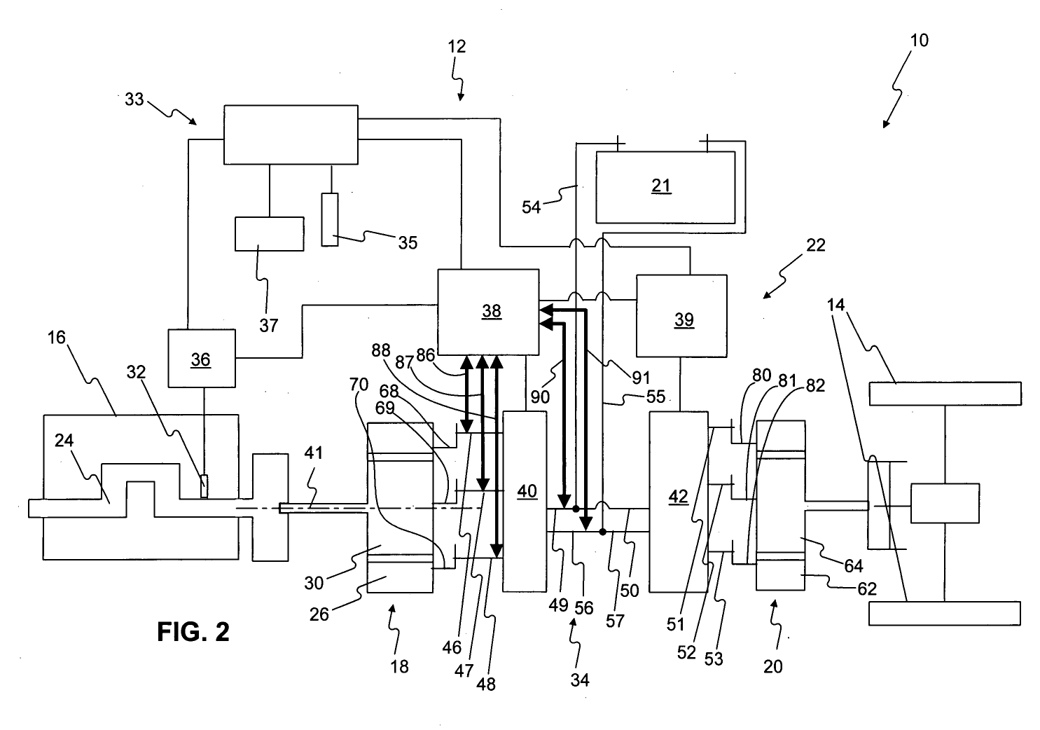

FIG. 2 shows a second embodiment of work machine 10. In the embodiment of work machine 10 shown in FIG. 2, controller 38 is not directly operatively connected to position/speed sensor 32. In this embodiment controller 36 may be configured to receive a signal relating to the position and/or speed of rotary output member 24 from position/speed sensor 32 and forward that signal or a derivative thereof to controller 38. As in the embodiment shown in FIG. 1, because rotor 30 is drivingly connected to rotary output member 24 at a fixed speed ratio, the signal provided by position/speed sensor 32 and the signal forwarded from controller 36 to controller 38 relates to the position and/or speed of rotor 30.

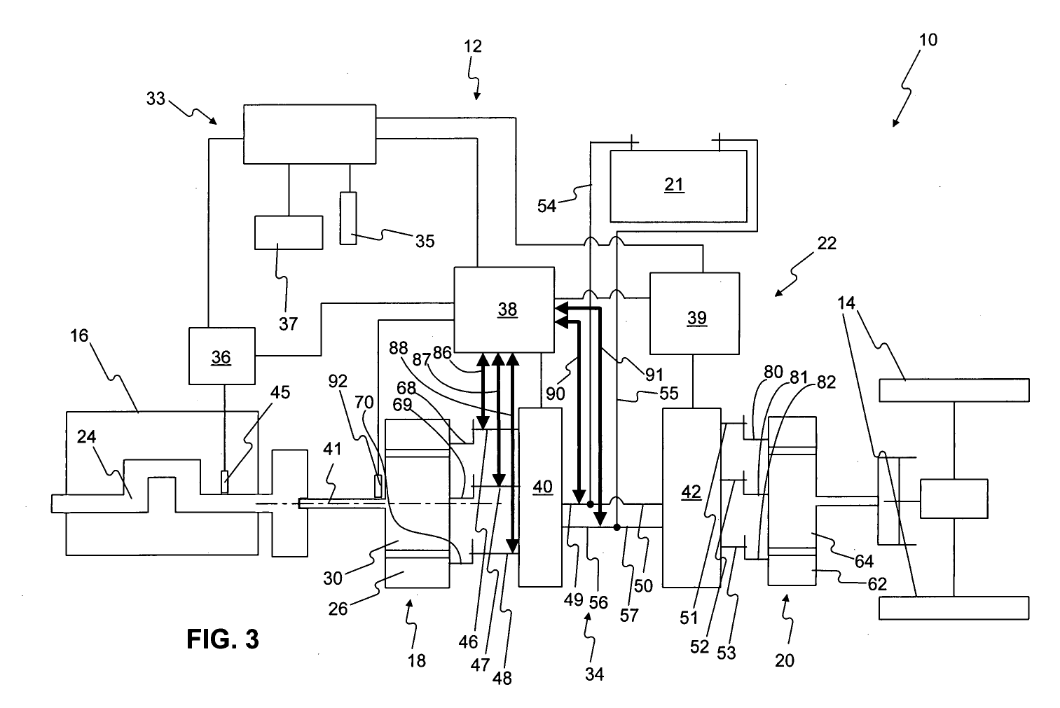

FIG. 3 shows a third embodiment of work machine 10. In the embodiment of work machine 10 illustrated in FIG. 3, controller 38 is operatively connected to a position/speed sensor 92. Position/speed sensor 92 may be arranged to directly sense the position and/or speed of rotor 30 and provide controller 38 with a signal relating to the position and/or speed of rotor 30. Except for being mounted in a different position, position/speed sensor 92 may be configured similarly to speed position sensor 32. Additionally, in the embodiment shown in FIG. 3, power source 16 may have a position/speed sensor 45 configured to provide controller 36 with a signal relating to the position and/or speed of rotary output member 24.

Machine 10 is not limited to the configurations shown in FIGS. 1, 2, and 3. For example, power source 16, electric machine 18, electric machine 20, and propulsion devices 14 may be connected in different manners. Whereas FIG. 1 shows rotary output member 24 connected directly to rotor 30, power system 12 may include various power-transfer components connected between rotary output member 24 and rotor 30, such as shafts, gears, clutches, belts and pulleys, and/or sprockets and chains. Additionally, rotary output member 24 and/or rotor 30 may be directly or indirectly drivingly connected to propulsion devices 14. Furthermore, power-system controls 22 may include one or more other controllers in addition to controllers 36, 38, 39 and/or power-system controls 22 may omit one or more of controllers 36, 38, 39. Moreover, power-system controls 22 may include various other types of logic systems, such as hardwired electric logic circuits. Furthermore, in some embodiments, machine 10 may omit propulsion devices 14 and/or electric machine 20.

### INDUSTRIAL APPLICABILITY

Machine 10 may have application wherever power is required for performing one or more tasks. Operation of machine 10 will be described herein below.

Under control of controller 36, power source 16 may rotate rotary member 24 and thereby rotate rotor 30 of electric machine 18. During such operation of power source 16, controller 36 may control the operation of various systems of power source 16 dependent upon inputs from various sources, such as operator controls 33, controllers 38, 39, and various sensors. Controller 36 may control various systems of power source 16, such as, for example, a fuel-injection system (not shown) and/or an ignition system (not shown) dependent upon the signal provided by position/speed sensor 32, 45.

While power source 16 is rotating rotor 30 of electric machine 18, controller 38 and power regulator 40 may control the operation of electric machine 18 by controlling electric current supply to the stator windings of stator 26. In embodiments where electric machine 18 is a synchronous type electric machine, electric machine 18 may operate as an electric motor or generator when alternating electric current flows in stator 26. Specifically, electric motor 18 may motor or generate when alternating current flowing through stator 26 has a frequency such that it creates one or more magnetic fields that rotate around rotor rotation axis 41 at the same speed as rotor 30. The phase relationship between the rotating magnetic field created by stator 26 and the poles of rotor 30 affects whether electric machine 18 motors or generates and the torque or current produced by electric machine 18.

Accordingly, in embodiments where electric machine 18 is a synchronous-type electric machine, controller 38 may need information relating to the speed and position of rotor 30 in order to effectively control the frequency and phase of alternating current in stator 26. Controller 38 may receive information relating to the position and speed of rotor 30 from position/speed sensor 32, 92. However, in some embodiments, the precise relationship between the signal provided by position/speed sensor 32, 92 and the position and speed of rotor 30 may not be known initially and/or this relationship may change over time.

Accordingly, in some embodiments power-system controls 22 may be configured to execute a method of calibrating the signal provided by position/speed sensor 32, 92. Some such methods may also include checking the validity of the speed and/or direction information provided by position/speed sensor 32, 92. In some embodiments, power-system controls 22 may be configured to automatically calibrate and validate the signal from position/speed sensor periodically or in response to predetermined events, such as every time operation of power source 16 is commenced.

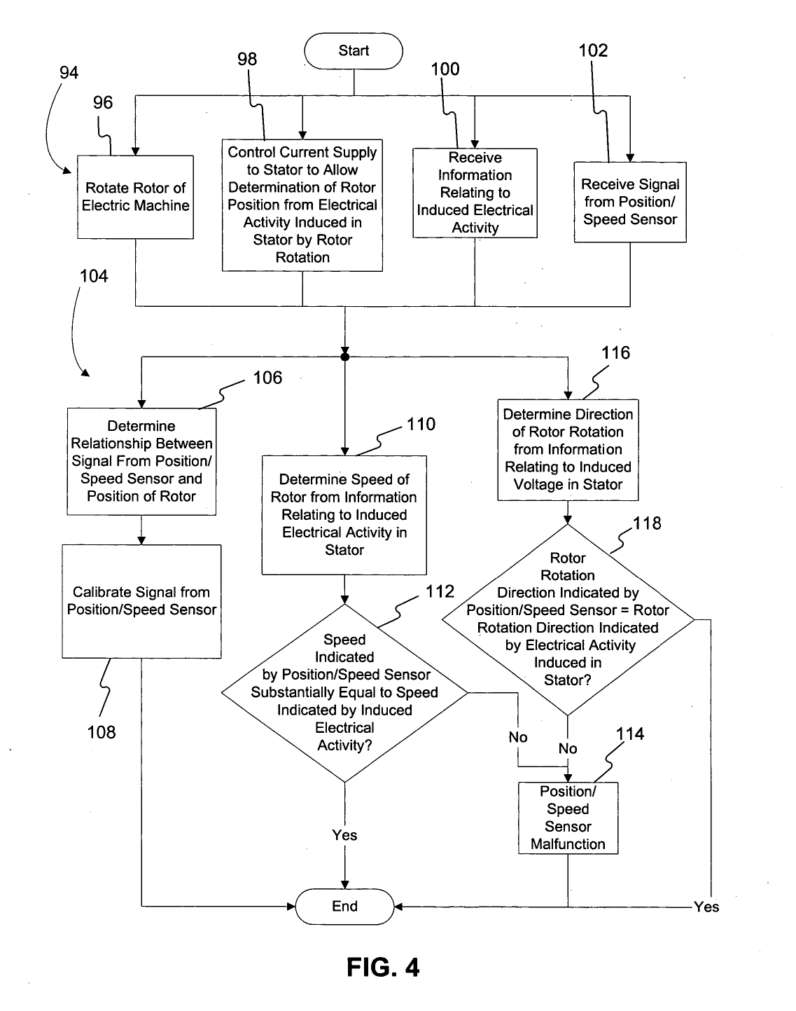

FIG. 4 contains a flow chart illustrating one method that power-system controls 22 may utilize to calibrate and validate the signal from position/speed sensor 32, 92. The method illustrated by FIG. 4 includes an initial data-gathering stage 94. In this stage, power-system controls 22 may cause power source 16 to rotate rotor 30 (step 96) while controller 38 and power regulator 40 control the electric current supply to stator 26 in a manner allowing determination of the position of rotor 30 from electrical activity induced in stator 26 (step 98). In data-gathering stage 94, controller 38 may also receive information relating to the induced electricity in stator 26. (step 100) Controller 38 may do so through information channels 86-88. Simultaneously, controller 38 may receive the signal produced by position/speed sensor 32, 92. (step 102) Controller 38 may remain in data-gathering stage 94 until controller 38 has gathered sufficient data to calibrate and validate the signal provided by position/speed sensor 32, 92, as is discussed below.

The manner of controlling electric current supply to stator 26 in order to allow determination of the position of rotor 30 from induced electrical activity in stator 26 may depend upon the configuration of electric machine 18. In embodiments where electric machine 18 is a permanent-magnet type electric machine, when rotor 30 rotates, rotor 30 may induce voltage that alternates as a function of the relative positions of the poles of rotor 30 and the poles of stator 26. The supply of current to stator 26 may be controlled in a manner such that one or more aspects of the pattern of the alternating voltage induced by rotating rotor 30 may be used to discern the position of rotor 30 at certain times. For example, controller 38 and power regulator 40 may supply no current to stator 26, which may allow determining the position of rotor 30 at various times, such as when the induced voltage at a terminal 68, 69, 70 is zero.

In embodiments where electric machine 18 is a switched-reluctance type electric machine, controlling the current supply to stator 26 in such a manner to allow determination of the position of rotor 26 from induced electrical activity in stator 26 may include supplying a pulsing current to one or more of terminals 68-70. In such embodiments, when power regulator 40 supplies pulsing electric current to one or more of terminals 68-70 while rotor 30 rotates, the current in the stator winding attached to that terminal 68-70 will rise at a rate that depends on the relative positions of the poles of rotor 30 and the poles of that stator winding. Accordingly, the position of rotor 30 at certain times may be determined using information about the current at terminals 68-70.

In addition to data gathering phase 94, the method illustrated by FIG. 4 may include a calibration and validation stage 104. In this stage, controller 38 may utilize the data previously gathered to determine the relationship between the signal received from position/speed sensor 32, 92 and the position of rotor 30. (step 106) For example, in embodiments where position/speed sensor 32, 92 produces pulses, controller 38 may determine the relationship between the pulses received from position/speed sensor 32, 92 and the position of rotor 30 at certain times. Controller 38 may then calibrate the signal from position/speed sensor 32, 92 dependent upon the relationship between the signal and the position of rotor 30. (step 108) Controller 38 may calibrate the signal from position/speed sensor 32, 92 by adjusting the manner in which controller 38 processes the signal received from position/speed sensor 32, 92. Additionally, in some embodiments, controller 38 and/or other components of power-system controls 22 may be operable to calibrate the signal from position/speed sensor 32, 92 by adjusting position/speed sensor 32, 92 and/or otherwise adjusting the manner in which the signal is produced.

Controller 38 may also determine whether the signal provided by position/speed sensor 32, 92 accurately indicates the speed of rotor 30. Controller 38 may utilize the information received relating to the electrical activity induced in stator 26 by rotating rotor 30 to determine the speed at which rotor 30 was rotating at certain times. (step 110) For example, controller 38 may use the information about the induced electrical activity in stator 26 to determine the position of rotor 30 at two times, use an internal clock to determine the time lapse between the two times, and calculate the speed of rotor 30 using this information. Controller 38 may then compare the calculated speed of rotor 30 at one or more times to the speed of the rotor indicated by position/speed sensor. 32, 92 at those one or more times. (step 112) If controller 38 determines there is a discrepancy between the speed of rotor 30 indicated by the different sources, controller 38 may produce an internal or external signal indicating that position/speed sensor 32, 92 is malfunctioning. (step 114)

In embodiments where position/speed sensor 32, 92 is configured to provide a signal relating to the direction of rotation of rotor 30, controller 38 may also determine whether the signal provided by position/speed sensor 32, 92 accurately indicates the direction of rotation of rotor 30. Controller 38 may determine the direction of rotation of rotor 30 from the information relating to the electrical activity induced in stator 26 by rotation of rotor 30. (step 116) For example, in embodiments where electric machine 18 is a permanent magnet-type electric machine and stator 26 has a multi-phase stator winding, controller 38 may determine the direction of rotation of rotor 30 from the phase relationships of the alternating voltages induced in the respective phase windings of stator 26. Controller 38 may then compare the direction of rotation of rotor 30 so determined with the direction of rotation of rotor 30 indicated by position/speed sensor 32. (step 118) In response to a discrepancy, controller 38 may create an internal or external signal indicating position/speed sensor 32, 92 is malfunctioning. (step 114)

Methods of calibrating and validating the signal from position/speed sensor 32, 92 are not limited to the embodiments discussed above in connection with FIG. 4. For example, rather than gathering data in a separate stage from calibrating and validating, controller 38 may gather data, calibrate, and validate concurrently. Additionally, in some embodiments, one or more of the actions of calibrating the signal provided by position/speed sensor 32, 92, verifying the accuracy of the speed indicated by position/speed sensor 32, 92, and verifying the accuracy of the direction indicated by position/speed sensor 32, 92 may be omitted. Furthermore, in addition to controller 38, other logic devices and/or systems may perform some or all of the actions of a method calibrating and/or validating the signal from position/speed sensor 32, 92. Moreover, the methods may be performed manually.

After it is calibrated, the signal from position/speed sensor 32, 92 may allow power-system controls 22 to know the precise position of the poles of rotor 30 with respect to the poles of stator 26. Accordingly, power-system controls 22 may thereafter control the current supplied to stator 26 without regard to whether the position of rotor 30 can be determined from electric activity in stator 30. Accordingly, power-system controls 22 may control the current supplied to stator 26 in order to meet various other objectives.

In some embodiments, power-system controls 22 may control electric machine 18 to keep the voltage in power lines 49, 56 substantially constant. Accordingly, if the voltage in power lines 49, 56 drops, controller 38 and power regulator 40 may control the current in stator 26 in such a manner to cause electric machine 18 to generate electricity. This may occur, for example, when controller 39 and power regulator 42 are causing electric machine 20 to operate as an electric motor, as is discussed below.

Conversely, in some embodiments, if the voltage in power lines 49, 56 increases above the target voltage, controller 38 and power regulator 40 may control the current in stator 26 to cause electric machine 18 to operate as an electric motor and drive rotary output member 24 of power source 16. For example, controller 38 and power-regulator 40 may operate electric machine 18 in this manner if electric machine 20 is operating as a generator to brake machine 10 and electric storage device 21 is incapable of storing all the electric energy generated by electric machine 20. Employing electric machine 20 to dissipate electrical energy by driving power source 16 may increase the magnitude of electrical braking that power-system 22 can provide for mobile machine 22 without overcharging electrical storage device 21. In embodiments where power source 16 is an internal combustion engine, considerable electrical energy may be dissipated in overcoming the pumping losses and friction of the power source.

Additionally, using electric energy recovered through electrical braking to drive power source 16, may enable power-system controls 22 to reduce the fuel consumption of power source 16.

In some embodiments, power-system controls 22 may operate electric machine 20 to accelerate and decelerate machine 10 dependent upon operator inputs. For example, if an operator transmits an acceleration request through operator controls 33, controller 39 and power regulator 42 may control the current supplied to stator 62 in a manner to cause electric machine 20 to operate as a motor to propel machine 10. The electrical energy for so operating electric machine 20 may come from electrical storage device 21, electricity generated by electric machine 18, electricity from an external source, such as an electrical trolley system, and/or other sources of electricity that may be connected to electrical power-transfer system 34. Additionally, in response to a deceleration request from an operator, controller 39 and power regulator 42 may cause electric machine 20 to generate electricity, which electricity may be stored in electrical storage device 21 and/or used by electric machine 18 as described above.

The disclosed embodiments may provide cost effective ways to ensure that power-system controls 22 receive accurate information about the position, speed, and/or direction of rotation of rotor 30. Calibrating and validating the signal from position/speed sensor 32, 92 after power system 12 is assembled may obviate the need to utilize expensive precision manufacturing methods to establish precise physical relationships between rotor 30 and position/speed sensor 32, 92 during assembly. Additionally, because no precise physical relationship needs to be established between rotor 30 and position/speed sensor 32, power-system controls 22 may utilize the signal provided by position/speed sensor 32. This may eliminate the need for separate position/speed sensors for power source 16 and electric machine 18. Additionally, the position/speed sensors of power sources are typically quite reliable, in part because they are often well-protected from the environment.

It will be apparent to those skilled in the art that various modifications and variations can be made in the power system and methods without departing from the scope of the disclosure. Other embodiments of the disclosed power system and methods will be apparent to those skilled in the art from consideration of the specification and practice of the power system and methods disclosed herein. It is intended that the specification and examples be considered as exemplary only, with a true scope of the disclosure being indicated by the following claims and their equivalents.

1. A power system, comprising:
a power source having a rotary output member;
an electric machine, including
a rotor drivingly connected to the rotary output member of the power source, and
a stator;
a sensor configured to provide a signal relating to at least one of a position of the rotor and a speed of the rotor; and
power-system controls configured to
control electric current supply to the stator dependent upon the signal and
control the power source dependent upon the signal.

2. The power system of claim 1, wherein:
the sensor is configured to provide a signal relating to at least the position of the rotor; and
controlling electric current supply to the stator dependent upon the signal includes
selectively supplying alternating electric current to the stator, and
controlling the phase of the alternating electric current dependent upon the signal.

3. The power system of claim 1, wherein the power-system controls are further configured to
prior to controlling electric current supply to the stator dependent upon the signal, calibrate the signal by
while the rotor is rotating, controlling electric current supply to the stator in a manner such that the position of the rotor may be determined from electrical activity induced in the stator by the rotation of the rotor, and
calibrating the signal dependent upon the electrical activity induced in the stator by rotation of the rotor.

4. The power system of claim 3, wherein:
the sensor is configured such that signal relates to at least the position of the rotor; and
calibrating the signal includes calibrating the relationship between the signal and the position of the rotor.

5. The power system of claim 1, wherein:
the sensor is configured in a manner such that the signal relates to at least the position of the rotor; and
controlling electric current supply to the stator dependent upon the signal includes
selectively supplying alternating electric current to the stator, and
controlling the phase of the alternating electric current dependent upon the signal.

6. The power system of claim 1, wherein:
the sensor is configured such that the signal relates to at least the speed of the rotor; and
the power-system controls are further configured to utilize information relating to the electrical activity induced in the stator by rotation of the rotor to determine whether the signal correctly relates to the speed of the rotor.

7. The power system of claim 1, wherein:
the sensor is configured such that the signal also relates to the direction of rotation of the rotor; and
the power-system controls are further configured to utilize information relating to the electrical activity induced in the stator by rotation of the rotor to determine whether the signal correctly relates to the direction of rotation of the rotor.

8. The power system of claim 1, wherein the power-system controls are configured to control the power source dependent upon the signal.

9. The power system of claim 1, wherein the power system is part of a mobile machine.

10. The power system of claim 9, wherein:
the mobile machine includes one or more propulsion devices;
the electric machine is a first electric machine;
the power system further includes a second electric machine drivingly connected to one or more of the propulsion devices;
the power-system controls are further configured to
when the mobile machine is in motion, selectively cause the second electric machine to brake the motion of the mobile machine by operating as a generator, and
while causing the second electric machine to brake motion of the mobile machine, selectively cause the first electric machine to operate as a motor and drive the rotary output member of the power source.

11. A method of operating a power system having an electric machine, the electric machine having a rotor and a stator, and the power system also having a sensor configured to provide a signal relating to at least one of a position of the rotor and a speed of the rotor, the method comprising:
while the rotor is rotating, controlling electric current supply to the stator in a manner such that the position of the rotor may be determined from electrical activity induced in the stator by the rotation of the rotor; and
calibrating the signal dependent upon the electrical activity induced in the stator by rotation of the rotor.

12. The method of claim 11, wherein the electric machine is a permanent-magnet type electric machine.

13. The method of claim 12, wherein controlling electric current supply to the stator in a manner such that the position of the rotor may be determined from electrical activity induced in the stator by the rotation of the rotor includes supplying no electric current to the stator.

14. The method of claim 11, wherein controlling electric current supply to the stator in a manner such that the position of the rotor may be determined from electrical activity induced in the stator by the rotation of the rotor includes supplying no electric current to the stator.

15. The method of claim 11, further including:
subsequent to calibrating the signal, controlling electric current supply to the stator dependent upon the signal.

16. The method of claim 15, wherein controlling electric current supply to the stator dependent upon the signal includes
selectively supplying alternating electric current to the stator, and
controlling the phase of the alternating current dependent upon the signal.

17. The method of claim 15, wherein:
the power system further includes a power source having a rotary output member drivingly connected to the rotor of the electric machine; and
the method further includes controlling the power source dependent upon the signal.

18. The method of claim 17, wherein the power source is an internal combustion engine.

19. The method of claim 15, wherein:
the power system further includes a power source having a rotary output member drivingly connected to the rotor of the electric machine; and
controlling electric current supply to the stator dependent upon the signal includes selectively supplying electric current to the stator in such a manner to cause the rotor of the electric machine to drive the rotary output member of the power source.

20. The method of claim 11, wherein:
the signal relates to at least the position of the rotor; and
calibrating the signal dependent upon the electrical activity induced in the stator by rotation of the rotor includes calibrating the relationship between the signal and the position of the rotor.

21. The method of claim 11, wherein:
the sensor is configured such that the signal relates to at least the speed of the rotor; and
the method of operating the power system further includes utilizing information relating to the electrical activity induced in the stator by rotation of the rotor to determine whether the signal correctly relates to the speed of the rotor.

22. The method of claim 11, wherein:
the sensor is configured such that the signal also relates to the direction of rotation of the rotor; and
the method of operating the power system further includes utilizing information relating to the electrical activity induced in the stator by rotation of the rotor to determine whether the signal correctly relates to the direction of rotation of the rotor.

23. The method of claim 11, wherein the electric machine is a switched-reluctance type electric machine.

24. The method of claim 23, wherein controlling electric current supply to the stator in a manner such that the position of the rotor may be determined from electrical activity induced in the stator by the rotation of the rotor includes supplying a pulsing current to the stator.

25. The method of claim 11, wherein controlling electric current supply to the stator in a manner such that the position of the rotor may be determined from electrical activity induced in the stator by the rotation of the rotor includes supplying a pulsing current to the stator.

26. The method of claim 11, wherein:
the power system is part of a mobile machine;
the electric machine is a first electric machine;
the power system further includes a second electric machine;
the power system further includes a power source having a rotary output member drivingly connected to the rotor of the first electric machine;
wherein the method of operating the power system further includes
when the mobile machine is in motion, selectively causing the second electric machine to brake the motion of the mobile machine by operating as a generator; and
subsequent to calibrating the signal and while causing the second electric machine to brake motion of the mobile machine, selectively causing the first electric machine to operate as a motor and drive the rotary output member of the power source.

27. A mobile machine, comprising:
one or more propulsion devices configured to receive power and utilize that power to propel the mobile machine;
a power system configured to selectively provide power to the one or more propulsion devices to propel the mobile machine, the power system including
an internal combustion engine having a rotary output member;
a first electric machine drivingly connected to the rotary output member of the internal combustion engine;
a second electric machine;
a sensor configured to provide a signal relating to at least one of the position, speed, and direction of rotation of the rotary output member of the internal combustion engine;
power-system controls configured to
while the mobile machine is in motion, selectively cause the second electric machine to brake the mobile machine by receiving power from one or more of the propulsion devices and utilizing that power to generate electricity; and
while causing the second electric machine to brake the mobile machine, selectively operate the first electric machine as an electric motor to drive the rotary output member of the internal combustion engine, including controlling the first electric machine dependent upon the signal.

28. (canceled)

29. The mobile machine of claim 27, further including:
wherein the first electric machine includes a rotor and a stator; and
wherein controlling the first electric machine dependent upon the signal includes supplying current to the stator of the first electric machine dependent upon the signal.

30. The mobile machine of claim 29, wherein:
the power-system controls are further configured to
prior to supplying electric current to the stator of the first electric machine dependent upon the signal, calibrate the signal by
while the rotor of the first electric machine rotates, controlling electric current supply to the stator in a manner such that the position of the rotor may be determined from electrical activity induced in the stator by the rotation of the rotor, and
calibrating the signal dependent upon the electrical activity induced in the stator by rotation of the rotor.

31. The mobile machine of claim 27, wherein:
the first electric machine includes a rotor and a stator;
operating the first electric machine as a motor includes
supplying alternating electric current to the stator of the first electric machine, and
controlling the phase of the alternating electric current dependent upon the signal.
